(19) United States
(12) Patent Application Publication
(10) Pub. No.: US 2025/0178750 A1
(43) Pub. Date: Jun. 5, 2025

(54) MANAGING MICROBIAL CONTAMINATION OF FUEL TANK

(71) Applicants: Airbus Operations Limited, FILTON, BRISTOL (GB); Airbus SAS, BLAGNAC (FR)

(72) Inventors: Adam FALLON, FILTON, BRISTOL (GB); Martin LEE, FILTON, BRISTOL (GB); Jean-Marie DAUTELLE, BLAGNAC (FR); Pierre-Henri BROUSSE, BLAGNAC (FR)

(21) Appl. No.: 18/844,169

(22) PCT Filed: Mar. 7, 2023
(86) PCT No.: PCT/GB2023/050526

§ 371 Date: Sep. 5, 2024

(30) Foreign Application Priority Data
Mar. 7, 2022 (GB) 2203143.9

(51) Int. Cl. B64F 5/40; B64F 5/60; G06Q 10/20

(52) U.S. Cl. CPC B64F 5/40; B64F 5/60; G06Q 10/20

(57) ABSTRACT

A computer-implemented method of determining a maintenance schedule or maintenance plan for a fuel tank of an aircraft. In a training phase, a predictive model is trained with training data. The training data is associated with fuel tanks of plural aircraft. The training data comprises environmental data indicative of an environmental parameter at locations of the plural aircraft, and test data which is indicative of a level of microbial contamination of fuel in fuel tanks of the plural aircraft. In a prediction phase, input data is received and the predictive model is operated, along with an optimisation algorithm, to determine a maintenance schedule or maintenance plan. One or more microbial contamination maintenance tasks are performed on the fuel tank based on the maintenance schedule or maintenance plan.

### CROSS-REFERENCES TO RELATED APPLICATIONS

This application is a national phase of International Patent Application No. PCT/GB2023/050526, filed on Mar. 7, 2023, which claims the benefit of Great Britain Patent Application No. 2203143.9, filed on Mar. 7, 2022, the entire disclosures of which are incorporated herein by way of reference

### FIELD OF THE INVENTION

The present invention relates to a method of maintaining a fuel tank of an aircraft, a method of determining a maintenance schedule or maintenance plan for a fuel tank of an aircraft, and a method of training a model to enable the model to predict a level of microbial contamination of a fuel tank of an aircraft.

### BACKGROUND OF THE INVENTION

Microbial contamination (such as growth of bacteria or fungi) can occur when water accumulates in an aircraft fuel tank. This can cause operational problems for the aircraft, so microbial contamination maintenance tasks may need to be undertaken to monitor and/or control the contamination level.

A known microbial contamination maintenance task is to drain the fuel tank of fuel completely every 28 days, and then add a fuel that has been mixed with a biocide containing Boron (at 100 ppm). This prevents the growth of microbes in the fuel tank. However, draining the tank is wasteful and the biocide can be harmful to the environment. The biocide is also expensive to buy, store and use. When the aircraft is used again, the biocide is burned as part of the fuel, which adds to its environmental impact. However, there may be a significant level of microbial contamination prior to the 28 days in some circumstances. In other circumstances, there is no risk of microbial contamination for much more than 28 days.

### SUMMARY OF THE INVENTION

A first aspect of the invention provides a method of maintaining a fuel tank of an aircraft, the method comprising: operating a computer to: receive input data, determine a microbial contamination prediction based on the input data, determine a maintenance schedule or maintenance plan based on the microbial contamination prediction, and output the maintenance schedule or maintenance plan; and performing one or more microbial contamination maintenance tasks on the fuel tank based on the maintenance schedule or maintenance plan.

Optionally the microbial contamination prediction predicts a level of microbial contamination at a current time or at a future time.

Optionally the microbial contamination prediction comprises a prediction which predicts a level of microbial contamination at a current time, and a forward prediction which predicts a level of microbial contamination at a future time.

Optionally the maintenance schedule or maintenance plan is determined by an optimization algorithm on a basis of a future operational plan for the aircraft which indicates timings and locations of future flights of the aircraft.

Optionally the input data comprises environmental data indicative of an environmental parameter such as temperature, humidity, proximity to farmland, or air content (for example pollutant content, sulfur content, salinity, or pollen content).

The environmental data may come from environmental data sources, or it may comprise aircraft environmental data (for instance indicating local temperature or humidity) obtained by one or more sensor of the aircraft.

Optionally the environmental data is indicative of an environmental parameter (such as temperature or humidity) inside the fuel tank. Alternatively the environmental data may be indicative of an environmental parameter (such as temperature or humidity) outside the fuel tank at a location of the aircraft.

Optionally the input data comprises temperature data indicative of a temperature; the microbial contamination prediction is determined based on an analysis of the temperature relative to a microbial growth temperature range with upper and lower bounds, and the microbial growth temperature range is a temperature range in which microbial growth is expected.

Optionally the input data comprises an indication of accumulated time within the microbial growth temperature range, optionally over a time period during which the temperature moves in and out of the microbial growth temperature range.

A further aspect of the invention provides a method of maintaining a fuel tank of an aircraft, the method comprising: operating a computer to: receive a future operational plan for the aircraft which indicates timings and locations of future flights of the aircraft, determine a maintenance schedule or maintenance plan based on the future operational plan, and output the maintenance schedule or maintenance plan; and performing one or more microbial contamination maintenance tasks on the fuel tank based on the maintenance schedule or maintenance plan.

Optionally a timing of the one or more microbial contamination maintenance tasks is specified by the maintenance schedule or maintenance plan.

The maintenance schedule or maintenance plan may consist of only a single microbial contamination maintenance task, or it may comprise a plurality of tasks including one or more microbial contamination maintenance tasks.

A further aspect of the invention provides a computer-implemented method of determining a maintenance schedule or maintenance plan for a fuel tank of an aircraft, the method comprising: receiving a future operational plan for the aircraft which indicates timings and locations of future flights of the aircraft; and determining a maintenance schedule or maintenance plan with an optimization algorithm based on the future operational plan, wherein a timing of one or more microbial contamination maintenance tasks is specified by the maintenance schedule or maintenance plan.

A further aspect of the invention provides a computer-implemented method of determining a maintenance schedule or maintenance plan for a fuel tank of an aircraft, the method comprising: receiving input data; determining a microbial contamination prediction with a predictive model based on the input data; and determining a maintenance schedule or maintenance plan with an optimization algorithm based on the microbial contamination prediction, wherein a timing of one or more microbial contamination maintenance tasks is specified by the maintenance schedule or maintenance plan.

Optionally the one or more microbial contamination maintenance tasks comprises a plurality of microbial contamination maintenance tasks, and timings of the microbial contamination maintenance tasks are specified by the maintenance schedule or maintenance plan.

Optionally the one or more microbial contamination maintenance tasks comprise adding biocide to the fuel tank, and/or testing a level of microbial contamination of fuel in the fuel tank and/or cleaning the fuel tank.

Optionally the one or more microbial contamination maintenance tasks comprise adding biocide to the fuel tank, and/or cleaning the fuel tank.

Optionally the microbial contamination prediction is determined by a predictive model, and the method further comprises training the predictive model with training data, wherein the training data is associated with plural aircraft, and the training data comprises environmental data indicative of an environmental parameter at locations of the plural aircraft, and test data which is indicative of a level of microbial contamination of fuel in fuel tanks of the plural aircraft.

A further aspect of the invention provides a method of training a predictive model to enable the predictive model to predict a level of microbial contamination of a fuel tank of an aircraft, the method comprising: training the predictive model with training data, wherein the training data is associated with fuel tanks of plural aircraft, and the training data comprises environmental data indicative of an environmental parameter at locations of the plural aircraft, and test data which is indicative of a level of microbial contamination of fuel in fuel tanks of the plural aircraft.

A further aspect of the invention provides a computer-implemented method of determining a maintenance schedule or maintenance plan for a fuel tank of an aircraft, the method comprising: in a training phase: training a predictive model with training data, wherein the training data is associated with fuel tanks of plural aircraft, and the training data comprises environmental data indicative of an environmental parameter at locations of the plural aircraft, and test data which is indicative of a level of microbial contamination of fuel in fuel tanks of the plural aircraft; and in a prediction phase: receiving input data, operating the predictive model to determine a microbial contamination prediction based on the input data, and operating an optimization algorithm to determine a maintenance schedule or maintenance plan based on the microbial contamination prediction.

The training data in any of the further aspects may come from environmental data sources, or it may comprise aircraft environmental data (for instance indicating local temperature or humidity) obtained by one or more sensor of each aircraft.

Optionally the environmental data of the training data is indicative of an environmental parameter (such as temperature or humidity) inside the fuel tank. Alternatively the environmental data of the training data may be indicative of an environmental parameter (such as temperature or humidity) outside the fuel tank at a location of the aircraft.

Optionally the maintenance schedule or maintenance plan is based on the microbial contamination prediction and on a future operational plan for the aircraft which indicates timings and locations of future flights of the aircraft.

Optionally the environmental parameter is a temperature, humidity, proximity to farmland, or air content (for example pollutant content, sulfur content, salinity, or pollen content).

Optionally the microbial contamination prediction predicts a level of microbial contamination at a current time or at a future time.

A further aspect of the invention provides a computer program product comprising software code adapted to determine a maintenance schedule or maintenance plan or train a predictive model, the computer program product being adapted to perform the method of any preceding aspect, when executed by a computer.

### BRIEF DESCRIPTION OF THE DRAWINGS

Embodiments of the invention will now be described with reference to the accompanying drawings, in which:

FIG. 1 shows a computer system;

FIG. 2 shows a training phase in which a predictive model is trained on training data;

FIG. 3 shows an aircraft;

FIG. 4 shows the predictive model of FIG. 2 operating in a prediction phase, providing input to an optimisation algorithm; and

FIG. 5 is a flowchart illustrating the main steps of a method of maintaining a fuel tank of the aircraft of FIG. 3.

### DETAILED DESCRIPTION OF THE PREFERRED EMBODIMENT(S)

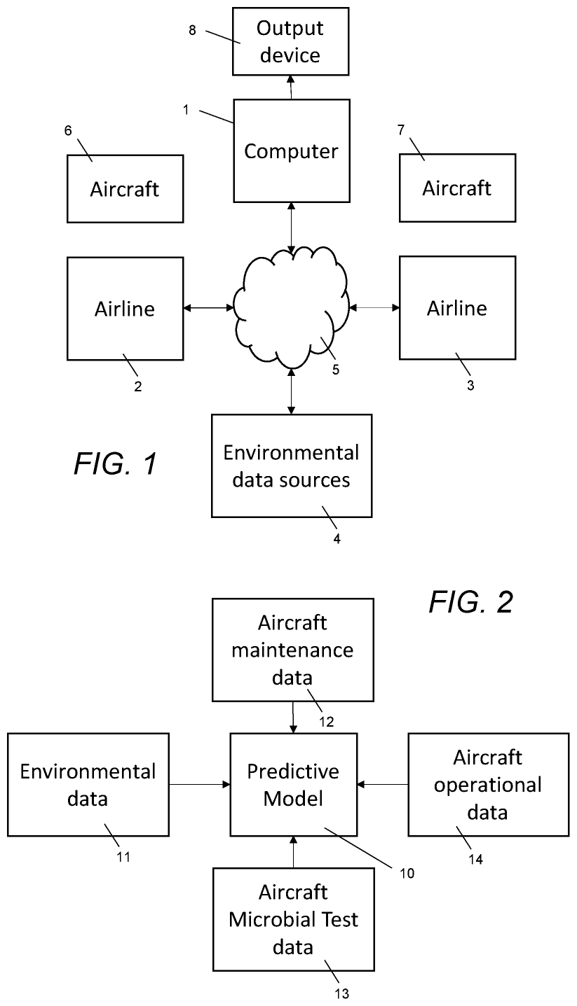

A computer 1 shown in FIG. 1 contains a program product comprising software code. The computer program product is adapted to determine and output a maintenance schedule or maintenance plan by the method described below, when run on the computer 1. The output may be via an output device 8, such as a printer or display screen.

The computer 1 is connected to airlines 2, 3 and environmental data sources 4 via a communication network 5. In this case only two airlines 2, 3 are shown but there may be more than two. The computer 1 runs an algorithm shown in FIGS. 2 and 4 which includes a predictive model 10 and an optimization algorithm 15.

The predictive model 10 may be developed by human developers looking at various factors and test data (i.e. whether there was contamination/water). The airlines 2, 3 feed back the test data and the predictive model 10 will continually evolve/improve.

Alternatively the predictive model 10 may be trained by machine learning with training data 11-14 shown in FIG. 2. The training data comprises environmental data 11, aircraft maintenance data 12, aircraft microbial test data 13 and aircraft operational data 14.

The environmental data 11 may come from the environmental data sources 4, which may be open sources or purchased data sets. The environmental data 11 may be indicative of an environmental parameter of one or more locations. For instance the environmental data 11 may be a data set indicating how the temperature, or another environmental parameter, varies over the course of a typical year for a particular airport, or a set of different airports.

Alternatively, some or all of the environmental data 11 may be aircraft environmental data (for instance indicating local temperature or humidity) obtained by sensors of the aircraft, and supplied by the airlines 2, 3.

By way of example, the environmental parameter may be a temperature, humidity, air content (for instance pollutant content, sulfur content, air salinity, or pollen level) or proximity to farmland.

Temperature can affect the degree of microbial contamination because warmer environments promote microbial growth.

Humidity can affect the degree of microbial contamination because humid environments promote microbial growth and mean the water needs to be drained more often from the fuel tank.

Air sulfur or pollen content can affect the degree of microbial contamination because sulfur or pollen in the air can be a feedstock for microbes.

Air salinity can also affect the degree of microbial contamination.

Proximity to farmland can indicate likely higher pollen level or other air content which can act as a feedstock for microbes.

The aircraft maintenance data 12, aircraft microbial test data 13 and aircraft operational data 14 are training data sets which contain information about particular aircraft, for instance the aircraft 6, 7 shown in FIG. 1, each belonging to a respective one of the airlines 2, 3.

The aircraft maintenance data 12 may be provided by the airlines 2, 3 via a technical request/customer support network, and may indicate draining and sampling qualitative information, findings etc. For instance the aircraft maintenance data 12 may indicate the dates on which each aircraft 6, 7 has had water drained from its fuel tanks, and the dates on which each aircraft 6, 7 has had a biocide added.

The aircraft operational data 14 may also be provided by the airlines 2, 3, and may indicate routes, airports, take-off times, landing times, etc. associated with the aircraft 6, 7, refueling locations, refuel quantities, and fuel type (including additives such as de-icer).

The aircraft microbial test data 13 may come from the airlines 2, 3 or another source, and they may indicate the results of various tests in which a level of microbial contamination of fuel in the fuel tanks of the aircraft 6, 7 is measured.

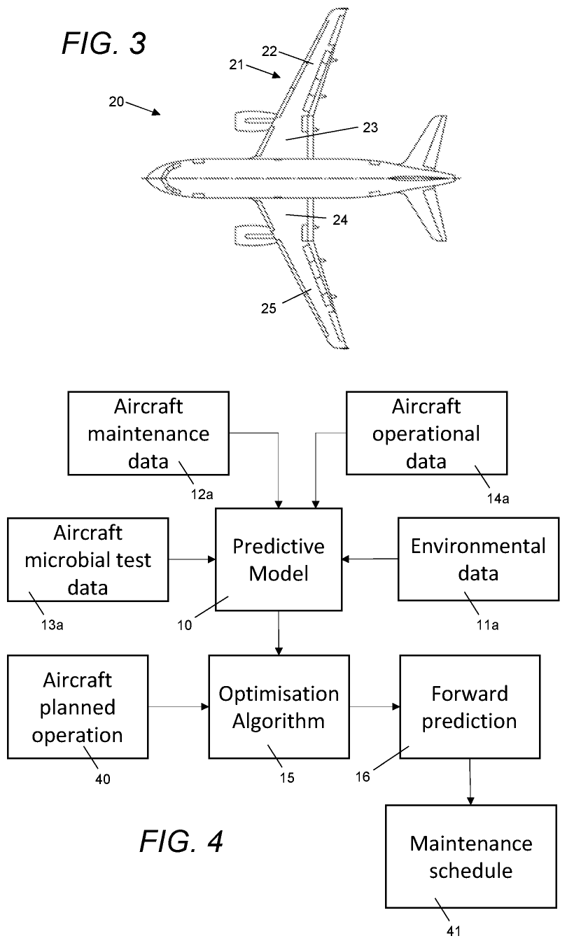

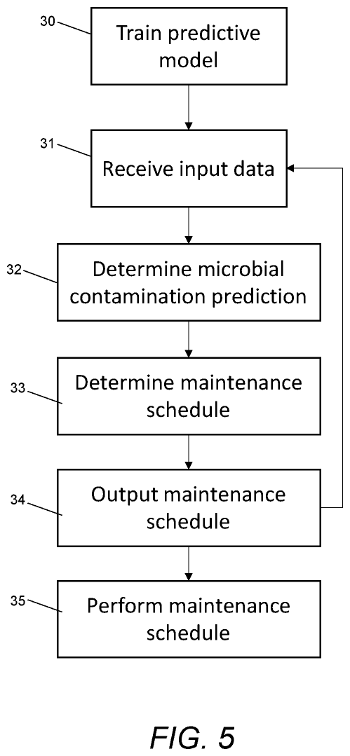

FIG. 3 shows an aircraft 20. The aircraft has wings 21 containing fuel tanks 22-25. A method of maintaining the fuel tanks 22-25 is shown in FIG. 5.

In a training phase 30 the predictive model 10 is trained with the training data 11-14 of FIG. 2. The training data 11-14 is associated with plural aircraft 6, 7 and comprises environmental data 11 indicative of an environmental parameter at locations of the plural aircraft 6, 7 and test data 12 which is indicative of a level of microbial contamination of fuel in fuel tanks of the plural aircraft 6, 7.

Table 1 gives an example of training data associated with aircraft 6 which has been stored at a first airport with low temperature and low humidity.

TABLE 1

| | Average | Average | |
|---|---|---|---|
| Day | temperature | humidity | Test data |
| 1 | 2° C. | 30% | |
| 2 | 3° C. | 40% | |
| 3 | 1° C. | 50% | |
| 4 | 3° C. | 25% | |
| 5 | 3° C. | 25% | Low microbe |
| | | | level |

Table 2 gives an example of training data associated with aircraft 7 which has been stored at a second airport with high temperature and high humidity.

TABLE 2

| | Average | Average | |
|---|---|---|---|
| Day | temperature | humidity | Test data |
| 1 | 20° C. | 90% | |
| 2 | 21° C. | 90% | Medium microbe |
| | | | level |
| 3 | 19° C. | 95% | |
| 4 | 18° C. | 80% | |
| 5 | 22° C. | 80% | High microbe |
| | | | level |

The environmental data (in this case temperature and humidity data) may be obtained from the environmental data sources 4, and therefore be indicative of the temperature or humidity at the airport where the aircraft is being stored. In this case the temperature and humidity in the fuel tanks 22-25 may not be the same as the temperature and humidity indicated by the environmental data. Thus the predictive model 10 may construe the temperature and humidity in the fuel tanks 22-25 from the environmental data.

Alternatively, the environmental data may be aircraft environmental data obtained by sensors of the aircraft 20—for instance temperature and humidity sensors located in each fuel tank 22-25. Such aircraft environmental data will be more directly indicative of the temperature and humidity inside the fuel tanks 22-25.

In the examples of Tables 1 and 2, the environmental data comprises temperature data indicative of a daily average temperature, and humidity data indicative of a daily average humidity. In other embodiments, the environmental data may be indicative of the temperature and humidity over shorter time periods—for instance hourly averages. This will enable the environmental data to keep track of relatively rapid changes during operation of the aircraft. For example when the aircraft is on the ground the temperature may be relatively constant, but during flight of the aircraft the temperature may vary rapidly and by large amounts depending on the altitude of the aircraft.

After the training phase 30, the predictive model 10 is capable of generating a microbial contamination prediction based on inputs 12a-14a in a prediction phase shown in FIG. 4. The prediction phase of FIG. 4 is typically performed when the aircraft 20 is parked.

As shown in FIG. 4, in the prediction phase the predictive model 10 is operated to receive input data 12a-14a and provide outputs to an optimization algorithm 15. The outputs of the predictive model 10 may include a microbial contamination prediction which predicts a level of microbial contamination at the current time, as well as other parameters such as fuel tank water level.

In the example of FIG. 4, the input data 12a-14a comprises environmental data 11a, aircraft maintenance data 12a, aircraft microbial test data 13a and aircraft operational data 14a, all associated with the aircraft 20. The input data 12a-14a is similar to the training data 12-14 used in the training phase of FIG. 2, so it will not be described again.

In the first iteration of the process of FIG. 4, the input data 12a-14a is historical data associated with a recent period of operation of the aircraft 20.

The optimization algorithm 15 receives the output(s) from the predictive model 10, and also receives a future operational plan 40 for the aircraft 20 which indicates timings and locations of future flights of the aircraft 20. For instance the future operational plan 40 may indicate routes, airports, take-off times, and landing times associated with planned future flights of the aircraft 20. This future operational plan 40 is used by the optimization algorithm 15, in combination with the output(s) from the predictive model 10, to determine an optimal maintenance schedule or maintenance plan 41. This involves two outputs: a forward prediction 16 which is a microbial contamination prediction for a future time based on the future operational plan 40, and a maintenance schedule or maintenance plan 41 which is based on this forward prediction 16. For instance if the aircraft 20 is expected to be stored in future at an airport with high temperature and high humidity for a long period of time, then high levels of microbial contamination will be predicted in the forward prediction 16, and the maintenance schedule or maintenance plan 41 will be tailored accordingly.

The forward prediction 16 may either be obtained from the predictive model 10, or determined by a different predictive model which is part of the optimization algorithm 15.

FIG. 5 represents the prediction phase of FIG. 4 in four steps 31-34 which run in a continuous loop. In a first step 31, the input data 12a-14a is received. In the next step 32 the predictive model 10 run by the computer 1 determines a microbial contamination prediction based on the input data 12a-14a, which predicts a current level of microbial contamination at the current time. For instance, the predictive model 10 will predict a high level of microbial contamination at the end of a period of storage at a high temperature location.

In the next step 33, the optimization algorithm 15 determines a maintenance schedule or maintenance plan 41 based on the forward prediction 16 of microbial contamination.

A timing of one or more tasks may be specified by the maintenance schedule or maintenance plan 41. By way of example the tasks may comprise draining water from the fuel tank, and/or draining fuel from the fuel tank, and/or adding a biocide to the fuel tank, and/or testing a level of microbial contamination of fuel in the fuel tank and/or cleaning the fuel tank (after it has been fully drained).

Cleaning the fuel tank typically remove microbes from structure of the fuel tank and/or removes microbes from the fuel tank. By way of example the cleaning may comprise: a hard cleaning action where a human enters the tank and actively cleans specific structures (for instance walls of the fuel tank) with areas of visible contamination; a soft cleaning action where no human tank entry is required (this would involve alternate means of performing a less aggressive form of cleaning, which would take less time and operational disturbance); or an enhanced draining action (no human tank entry required) which provide a means of draining the sump areas of the tank, otherwise not accessible via the water drain valve (otherwise referred to as ‘undrainable fuel’). Such sump areas are likely to contain microbial film.

A simple example of a maintenance schedule 41 output by the optimization algorithm 15 is given in Table 3.

TABLE 3

| Day | Task |
|---|---|
| 4, 8, 12, 16, 18, 20 | Drain water |
| 17, 19 | Test contamination level |
| 22 | Drain tank and add fuel with biocide |

The maintenance schedule of Table 3 is based on a future operational plan 40 for the aircraft 20 which indicates that the aircraft is flying a first route with low temperature and low humidity in a first period (days 1 to 16) then flying a second route with high temperature and high humidity in a second period (days 17 to 22).

The forward prediction 16 indicates a low level of microbial contamination during the first period, so the maintenance schedule or maintenance plan of Table 3 only requires water to be drained every four days.

The forward prediction 16 indicates a high level of microbial contamination during the second period, so the maintenance schedule of Table 3 requires water to be drained more frequently (every two days). Also, in the second period, three microbial contamination maintenance tasks are scheduled: two contamination level tests on days 17 and 19, then biocide is added to the tank on day 22.

In the example of Table 3 the maintenance schedule comprises a list of nine tasks: four water draining tasks (which are not microbial contamination maintenance tasks) and three microbial contamination maintenance tasks.

Once the maintenance schedule of Table 3 has been determined in step 33 and output in step 34 by the output device 8, then in step 35 of FIG. 5 maintenance personnel may perform the tasks specified by the maintenance schedule, in order to keep a level of water and microbial contamination sufficiently low during the future flights.

Steps 31-34 may operate in a loop as shown in FIG. 5. This enables the maintenance schedule 41 to be changed in real time, or further tests requested, or an alert given, if location conditions change. For example, if the weather during the first period is warmer or more humid than expected, then the maintenance schedule of Table 3 may be altered to do an extra water draw and/or do a contamination check.

Table 4 gives an example how the maintenance schedule of Table 3 could be changed if the temperature and humidity on the first route become higher than expected on day 9.

TABLE 4

| Day | Task |
|---|---|
| 4, 8, 10, 12, 14, 16, 18 | Drain water |
| 10, 13, 17 | Test contamination level |
| 20 | Drain tank and add fuel with biocide |

The embodiment above is an example of the present invention in which a predictive model 10 is trained by machine learning as shown in FIG. 2 with training data 11-14 which may include temperature data (either from environmental data sources 4 or from temperature sensors onboard the aircraft). Similarly, in the prediction phase of FIG. 5 the predictive model 10 (and any predictive model which runs as part of the optimization algorithm 15) determines a microbial contamination prediction based on input data 12a-14a which may include temperature data (either from environmental data sources 4 or from temperature sensors onboard the aircraft).

In an alternative embodiment of the invention the predictive model 10 (and any predictive model which runs as part of the optimization algorithm 15) may be a more basic digital twin which is not trained by machine learning. Such a digital twin will perform a prediction process similar to FIG. 5, but without the training phase 30.

The current or future microbial contamination prediction determined by the digital twin in step 32 or step 33 may be determined based on an analysis of the temperature relative to a microbial growth temperature range with upper and lower bounds.

The microbial growth temperature range is a temperature range in which microbial growth is expected. For instance the microbial growth temperature range may have an upper bound of 57° C. and a lower bound of 5° C., or the microbial growth temperature range may have an upper bound of 40° C. and a lower bound of 10° C.

Table 5 below gives an example in which the average temperature at the location of the aircraft is in the microbial growth temperature range during hours 1, 2, 8 and 9 when the aircraft is on the ground; and not in the microbial growth temperature range during hours 3-7 when the aircraft is in flight.

TABLE 5

| | Average | In | |
|---|---|---|---|
| Hour | temperature | range? | AMCTT |
| 1 | 24° C. | Yes | 1 hr |
| 2 | 25° C. | Yes | 2 hr |
| 3 | −10° C. | No | 2 hr |
| 4 | −20° C. | No | 2 hr |
| 5 | −30° C. | No | 2 hr |
| 6 | −20° C. | No | 2 hr |
| 7 | −10° C. | No | 2 hr |
| 8 | 15° C. | Yes | 3 hr |
| 9 | 17° C. | Yes | 4 hr |

The digital twin may compare the temperatures to the upper and lower bounds and determine an accumulated microbial contamination threat time (AMCTT), which in the case of Table 5 is 4 hours. The AMCTT can then be used to determine the microbial contamination prediction (a higher threat time predicting a higher level of microbial contamination).

Table 2 includes a column indicating the AMCTT, which is an indication of accumulated time within the microbial growth temperature range over a 9 hour time period during which the temperature moves in and out of the microbial growth temperature range.

Tables 3 and 4 give examples of maintenance schedules with plural tasks which are determined by the optimization algorithm 15 in step 33 of FIG. 5 and output by the output device 8 in step 34 of FIG. 5. The maintenance schedule of Table 3 comprises a list of nine tasks: six water draining tasks (which are not microbial contamination maintenance tasks) and three microbial contamination maintenance tasks. The maintenance schedule of Table 4 comprises a list of eleven tasks: seven water draining tasks (which are not microbial contamination maintenance tasks) and four microbial contamination maintenance tasks.

In other embodiments of the invention, instead of outputting a schedule with plural tasks, the optimization algorithm 15 may instead generate a more basic maintenance plan which consists of only a single microbial contamination maintenance task.

Tables 3 and 4 give examples of maintenance schedules in which timings of the tasks are specified (in this case specifying a day for each task). In other embodiments of the invention, instead of outputting a schedule or plan in which timings of tasks are specified, the optimization algorithm 15 may instead generate a more basic schedule or plan in which a timing (or timings) of the task (or tasks) is (or are) not specified.

Example of basic maintenance plans are given in Table 6 below. An aircraft is about to be stored, and the optimization algorithm 15 generates a maintenance plan for each tank of the aircraft. Each maintenance plan consists of a single task which is to be performed for that tank at any time during the storage of the aircraft.

TABLE 6

| | Fuel | Average air | | |
|---|---|---|---|---|
| | quantity at | temperature | Water | |
| Tank | storage | for period | volume | Task |
| Centre tank | 0 kg | 15° C. | xx liters | Add biocide |
| Port Wing | 4 kg | 14° C. | xx liters | None |
| tank | | | | |
| Starboard | 4 kg | 14° C. | xx liters | Water drain |
| Wing tank | | | | |

In this case a microbial contamination maintenance task (add biocide) is specified for the center tank, but no microbial contamination maintenance task is specified for either of the wing tanks.

Where the word ‘or’ appears this is to be construed to mean ‘and/or’ such that items referred to are not necessarily mutually exclusive and may be used in any appropriate combination.

Although the invention has been described above with reference to one or more preferred embodiments, it will be appreciated that various changes or modifications may be made without departing from the scope of the invention as defined in the appended claims.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method of maintaining a fuel tank of an aircraft, the method comprising:
operating a computer to: receive input data, determine a microbial contamination prediction based on the input data, determine a maintenance schedule or maintenance plan based on the microbial contamination prediction, and output the maintenance schedule or maintenance plan; and
performing one or more microbial contamination maintenance tasks on the fuel tank based on the maintenance schedule or maintenance plan.

2. A method according to claim 1, wherein the maintenance schedule or maintenance plan is determined by an optimization algorithm on a basis of a future operational plan for the aircraft which indicates timings and locations of future flights of the aircraft.

3. A method according to any claim 1, wherein the input data comprises environmental data indicative of an environmental parameter.

4. A method according to claim 1, wherein the input data comprises temperature data indicative of a temperature; the microbial contamination prediction is determined based on an analysis of the temperature relative to a microbial growth temperature range with upper and lower bounds, and the microbial growth temperature range is a temperature range in which microbial growth is expected.

5. A method of maintaining a fuel tank of an aircraft, the method comprising:
operating a computer to: receive a future operational plan for the aircraft which indicates timings and locations of future flights of the aircraft, determine a maintenance schedule or maintenance plan based on the future operational plan, and output the maintenance schedule or maintenance plan; and
performing one or more microbial contamination maintenance tasks on the fuel tank based on the maintenance schedule or maintenance plan.

6. A method according to claim 1, wherein a timing of the one or more microbial contamination maintenance tasks is specified by the maintenance schedule or maintenance plan.

7. (canceled)

8. (canceled)

9. (canceled)

10. A method according to claim 4, wherein the input data comprises an indication of accumulated time within the microbial growth temperature range.

11. A method according to claim 10, wherein the indication comprises an indication of accumulated time within the microbial growth temperature range over a time period during which the temperature moves in and out of the microbial growth temperature range.

12. A method according to claim 1, wherein the one or more microbial contamination maintenance tasks comprises a plurality of microbial contamination maintenance tasks, and timings of the microbial contamination maintenance tasks are specified by the maintenance schedule or maintenance plan.

13. A method according to claim 1, wherein the one or more microbial contamination maintenance tasks comprise adding biocide to the fuel tank, and/or testing a level of microbial contamination of fuel in the fuel tank, and/or cleaning the fuel tank.

14. A method according to claim 1, wherein the one or more microbial contamination maintenance tasks comprise adding biocide to the fuel tank, and/or cleaning the fuel tank.

15. A method according to claim 1, wherein the microbial contamination prediction is determined by a predictive model, and the method further comprises training the predictive model with training data, wherein the training data is associated with plural aircraft, and the training data comprises environmental data indicative of an environmental parameter at locations of the plural aircraft, and test data which is indicative of a level of microbial contamination of fuel in fuel tanks of the plural aircraft.

16. (canceled)

17. A computer-implemented method of determining a maintenance schedule or maintenance plan for a fuel tank of an aircraft, the method comprising:
in a training phase: training a predictive model with training data, wherein the training data is associated with fuel tanks of plural aircraft, and the training data comprises environmental data indicative of an environmental parameter at locations of the plural aircraft, and test data which is indicative of a level of microbial contamination of fuel in fuel tanks of the plural aircraft; and
in a prediction phase: receiving input data, operating the predictive model to determine a microbial contamination prediction based on the input data, and operating an optimization algorithm to determine a maintenance schedule or maintenance plan based on the microbial contamination prediction.

18. A method according to claim 17, wherein the maintenance schedule or maintenance plan is based on the microbial contamination prediction and on a future operational plan for the aircraft which indicates timings and locations of future flights of the aircraft.

19. A method according to claim 3, wherein the environmental parameter is a temperature, humidity, proximity to farmland, or air content (for example pollutant content, sulfur content, salinity, or pollen content).

20. A method according to claim 1, wherein the microbial contamination prediction predicts a level of microbial contamination at a current time or at a future time.

21. A method according to claim 1, wherein the microbial contamination prediction predicts a level of microbial contamination at a future time.

22. A method according to claim 3, wherein the environmental data is obtained by one or more sensors of the aircraft.

23. A non-transitory computer readable media storing a computer program product comprising software code configured to determine a maintenance schedule or maintenance plan, the computer program product being configured to perform the method of claim 17 when executed by a computer.
